(19) United States
(12) Patent Application Publication
(10) Pub. No.: US 2010/0179459 A1
(43) Pub. Date: Jul. 15, 2010

(54) Apparatus For Stimulating the Human Body by Means of Vibrations

(75) Inventors: Michael Koch, Biberist (CH); Thomas Schuler, Sumiswald (CH)

Correspondence Address: Levenfeld Pearlstein, LLC;Intellectual Property Department, 2 North LaSalle, Suite 1300, Chicago, IL, 60602, US

(73) Assignee: POWER PLATE INTERNATIONAL LTD., London (UK)

(21) Appl. No.: 11/577,855

(22) PCT Filed: Oct. 25, 2005
(86) PCT No.: PCT/CH05/00626

§ 371 Date: Jan. 11, 2010

(30) Foreign Application Priority Data
Oct. 25, 2004 (EP) 04405659.6

(51) Int. Cl. A61H 1/00

(52) U.S. Cl. 601/53

(57) ABSTRACT

In one aspect of the invention, an apparatus for stimulating the human body by means of vibrations comprises a vibrating plate coupled by first elastic elements to an intermediate element. The intermediate element, which can be substantially disk-shaped and has a basic layout similar to that of the vibrating plate, is coupled by second elements to a base plate designed to rest on a support in the operational state of the apparatus. The vibration generator comprises weights rotated by a drive and eccentrically arranged relative to a rotational axis. The shaft that carries the weights is rotatably mounted and preferably coupled directly to the vibrating plate, i.e., without elastic, vibration-dampening elements. In another aspect of the invention, the electric motor that drives the weights is arranged on the base place, for example, rather than on the vibrating plate, and is coupled, for example by means of an articulated shaft, to a shaft on which the weights are arranged.

### CROSS-REFERENCE TO RELATED APPLICATIONS

This application claims priority to and the benefit of European Application No. 04405659.6 filed on 25 Oct. 2004 which is incorporated by reference in its entirety.

### BACKGROUND

The invention relates to an apparatus for stimulating the human body by means of vibrations, such as can be used for muscle training or quite generally for stimulating the body.

Such apparatus may be in the form of fitness apparatus having a vibrating platform, on which a user stands or sits or on which he/she rests a body part. There is also the possibility for a user to pick up belt loops fixed to the platform and to stretch them. The vibrations bring about reactions of the body, and a stimulating effect as well as a training effect result.

One example of such an apparatus can be found in the international laid-open specification WO 02/053078. The vibrating platform (also referred to as the oscillating plate) is set in motion by a vibrator. The vibrator comprises a motor, which is fitted to the underside of the plate and moves an eccentric weight. Owing to the inertia, the platform oscillates as the weight rotates. The oscillating plate is fitted to a frame, which rests on oscillation-damping blocks which stand directly on the floor. As a deviation from this principle, apparatus with a vibrating platform are known in which this platform rests on a base plate, which is as heavy as possible and which for its part is in contact with the floor, by means of oscillation-damping elements.

In both cases, vibrations are also transferred to the floor, which, depending on the location, may result in a severe nuisance in terms of undesirable excess noise and even in damage to buildings. In addition, the entire apparatus does not have any elements which are decoupled from the oscillation, with the result that electronic components belonging to the apparatus may continuously vibrate in the operating state of the apparatus and may cause long-term damage. If it is intended for as few oscillations as possible to be transferred to the foundation, the base plate needs to be very heavy, which is of course detrimental to the maneuverability of the apparatus.

The motor, which is fitted directly to the oscillating plate, either needs to be designed to be very solid, in which case it is also correspondingly expensive, or it likewise suffers longer-term damage owing to the vibrations.

Solutions with a forcibly guided oscillating plate are known, in particular for three-dimensional oscillations (in the style of rocking movements) to be controlled in a targeted manner. These solutions are problematic in terms of wear and, in the event of considerable differences in weight of the users, may result in the motor being subject to overloads; in addition, the problems of the elements co-vibrating in an undesirable manner and of the nuisance in terms of noise are also not solved in these solutions.

### SUMMARY

The object of the invention is to make available an apparatus having an oscillating plate which overcomes disadvantages of existing apparatus and in which, in particular, as few vibrations as possible are transferred to the foundation and/or to the drive.

In accordance with a first aspect of the invention, the object is achieved by virtue of the fact that the oscillating plate is coupled to an intermediate element via first elastic elements and this intermediate element is coupled to a basic element (i.e. a base plate, a basic frame or a basic housing) via second elastic elements, which basic element is designed to rest on a foundation in the operating state of the apparatus. The oscillation exciter has weights, which are set into rotational movements by a drive and which are fitted eccentrically with respect to an axis of rotation. The shaft guiding the weights is in this case preferably coupled directly, i.e. not via elastic oscillation-damping elements, to the oscillating plate and mounted on it in such a manner that it can rotate. Apart from the coupling via the intermediate element and the first and second elastic elements, the basic element is decoupled in terms of vibrations from the oscillating plate.

The intermediate element preferably forms a co-oscillating counterweight, which oscillates in phase opposition with respect to the oscillating plate. Ideally, this takes place with the same force amplitude. Numerical simulations which can approximately calculate the force amplitude as a function of the rigidity of the first and second elastic elements and the mass of the oscillating plate and the intermediate element, are known per se. It has been shown that particularly effective decoupling of the base plate or of the basic frame from the oscillating plate is achieved if the mass of the intermediate element exceeds a minimum mass, i.e. is, for example, at least 20 kg, preferably at least 35 kg, particularly preferably at least 40 kg, in an apparatus for users of average weight and training.

The intermediate element may be essentially in the form of a plate and may have, for example, a similar basic outline to the oscillating plate. It may run parallel to said oscillating plate and have cutouts at the location where an electric motor of the oscillation exciter rests in the corresponding lateral position on the oscillating plate or on the basic element (see below). This allows for a compact design with a limited distance between the basic element and the oscillating plate.

In accordance with a second aspect of the invention, at least one electric motor forming the electric drive is arranged not on the oscillating plate but on a component, such as the base plate, the basic frame or the basic housing, for example, which is removed therefrom and decoupled therefrom as far as possible in terms of oscillations. As in the first aspect, the oscillations are caused by weights which are set into rotational movements by a drive and are fitted eccentrically with respect to an axis of rotation. The shaft which guides the weights is coupled directly, i.e. not via elastic oscillation-damping elements, to the oscillating plate and is mounted thereon in such a manner that it can rotate. The torque transfer between the at least one electric motor and the shaft takes place via a suitable transfer mechanism, which may contain, for example, a propeller shaft or a belt or chain drive.

Often the oscillation exciter has at least two eccentric weights or groups of weights (for example pairs of weights), which rotate in opposition. It is thus possible for the oscillating plate to preferably oscillate in one direction, for example the vertical, while the effect of the eccentric weights with respect to the other directions is compensated for. In accordance with one preferred embodiment, the two weights or groups of weights are driven by the same electric motor, the torques being transferred to the shafts of the two weights/groups of weights via belt, chain or gearwheel drive means. In addition to an obvious reduction in costs, one motor costs less than two motors, this also has the effect that the synchronization of two drives is not an issue, i.e. opposite rotation in phase is easy to achieve with such a drive mechanism.

Particularly preferred is the combination of the two aspects of the invention. In this case, the shape of the intermediate element, which can be arranged between the base plate or the basic frame or the basic housing and the oscillating plate, is matched correspondingly. If the intermediate element is, for example, in the form of a plate, it has an opening or cutout at a central point, through which opening or cutout elements of the transfer mechanism can be passed. Specifically, the intermediate element may be in the form of a disk with at least one opening or else have the shape of a horseshoe or ring, be in the form of a W or have any other suitable shape with preferably flat dimensions.

### BRIEF DESCRIPTION OF THE DRAWINGS

Embodiments of the invention will be described in the text which follows with reference to drawings, in which:

FIG. 1 shows, as a basic sketch, a section through one embodiment of the invention in accordance with its first aspect.

FIG. 2 shows an exploded illustration of one embodiment of the first aspect of the invention.

FIG. 3 shows, as a basic sketch, a section through one embodiment of the invention in accordance with its second aspect.

FIG. 4 shows, as a basic sketch, a section through one embodiment of the invention with a combination of both aspects.

FIG. 5 shows an exploded illustration of essential elements of one embodiment of the invention which combines both aspects.

FIG. 6 shows an illustration of elements of a mechanism which transfers torques produced by an electric motor to two groups of eccentrics rotating in opposition.

FIG. 7 shows a very schematic illustration of a solution having an oscillation exciter, which has only a single electric motor, to which two eccentrics (or groups of eccentrics) are coupled.

### DETAILED DESCRIPTION OF THE EMBODIMENTS

The apparatus in FIG. 1 has an oscillating plate 1, which can be caused to vibrate for stimulating a user. The oscillating plate is coupled to an intermediate element 3 via a first elastic element, namely a first spring 2. This intermediate element 3 is for its part coupled to a base plate 5 via a second elastic element, namely a second spring 4. The base plate rests on a foundation 6, for example a mat of a fitness room, it being possible for further damping elements 7 to be provided in a manner known per se. Illustrated only schematically is an oscillation exciter 8, which contains an electrically driven shaft having at least one eccentric fitted thereto. The oscillation exciter is coupled directly to the oscillating plate 1, to be precise such that forces of inertia acting on the bearing of the shaft are transferred undamped to the oscillating plate.

The intermediate element 3 may be in the form of an essentially intrinsically rigid, for example plate-shaped body. However, it may also contain at least one weight, which can move within certain limits in relation to the rest of the intermediate element. In this embodiment, the intermediate element therefore has an intermediate-element basic body and material which can move in relation thereto. The movable material may be intrinsically loose, i.e. not nondeformable. For example, the intermediate-element basic body may have an intrinsically closed water tank, possibly with transverse webs, the movable material being a water filling. In a second example, the movable material is particulate, for example dust, sand or fine gravel. Then, for example, the intermediate-element basic body has, in addition to a plate-shaped component, a plastic housing for the particulate material, or the loose material is introduced into a material sack or the like. The movable material can, however, also be one or more intrinsically rigid bodies, which are coupled to the intermediate-element basic body by means of a spring. It has been shown that the decoupling in terms of oscillations between the oscillating plate and the base plate or the basic housing by means of the intermediate element functions particularly effectively if said intermediate element contains movable material.

The first elastic elements and preferably also the second elastic elements are coupled to the basic body of the intermediate element.

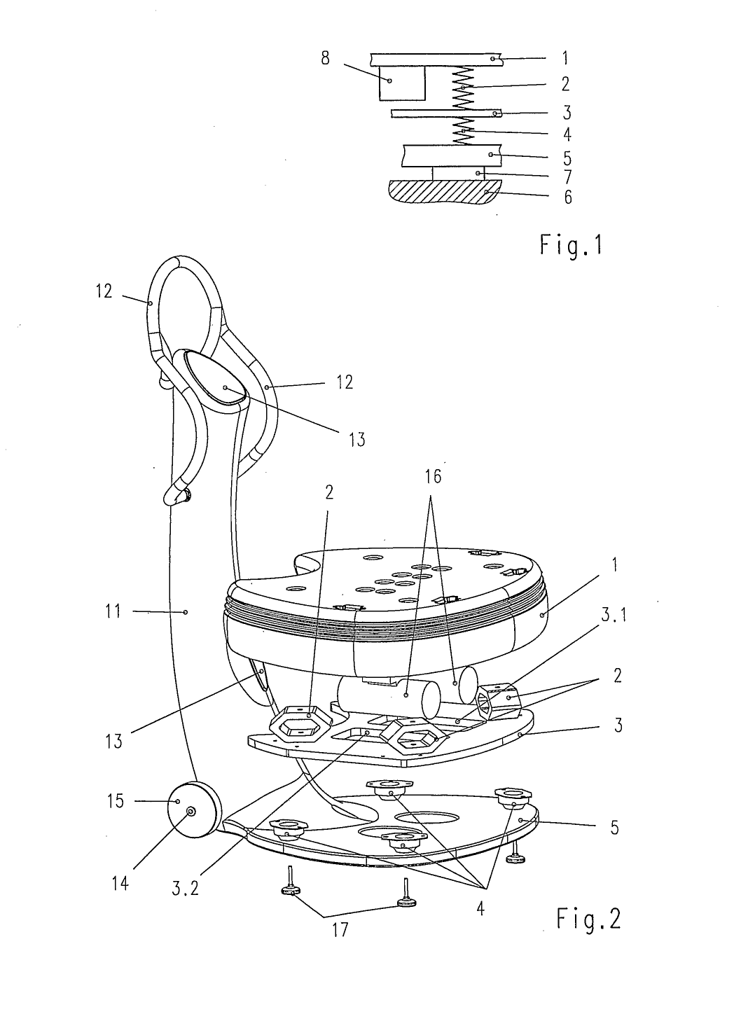

FIG. 2 shows an exploded illustration of an embodiment in accordance with the principle illustrated in FIG. 1. The base plate 5 is essentially rigidly connected to a structure 11, which includes handles 12 for the user and a control panel 13. In the interior of the structure or fitted to it there are also control electronics and possibly switched mode power supplies or the like. A wheel axle 14 with transport rollers 15, by means of which the apparatus can be transported over short distances, is optionally connected to the base plate. The oscillating plate 1 is manufactured from a rigid glass-fiber composite material or any other desired suitable material (reinforced plastic, metal alloy etc.) and has a standing area with a pleasant feel for the user, for example owing to an anti-slip covering or an anti-slip mat. The oscillating plate 1 also has fixing holes for electric motors and elastic elements (in this case illustrated as being round) and for belt loops (in this case illustrated as being angular). The intermediate element 3 is in this case intrinsically rigid, essentially in the form of a plate, and has openings 3.1, 3.2. In the embodiment illustrated, these openings serve the purpose of providing space for two electric motors 16, which are both fixed to the oscillating plate and, via a shaft, set in each case one eccentric (not illustrated in the figure) or one group of eccentrics into rotational movement. The electric motors are preferably designed such that, in at least one operating mode, they set the eccentrics/groups of eccentrics into a movement in opposition to one another, with the result that, for example, only the vertical component of the forces of inertia is converted into vibrational movements, while other components of the forces of inertia are compensated for. For this purpose, the electric motors can be synchronized with one another via electrical or electronic control means. However, this is not required under certain circumstances: if the electric motors have the same rotation speed and the oscillating plate is sufficiently rigid, synchronization already takes place owing to the vibratory coupling of the electric motors to one another.

In the exemplary embodiment illustrated, the first elastic elements 2 are in the form of honeycombed elastomeric bodies, while the second elastic elements 4 are symmetrical in the plane of the plate. Damping feet 17 are likewise illustrated. These damping feet are optional and can also be omitted or be replaced by felt rests or the like.

### EXAMPLES

The following parameters have been used in a first example of spring rigidities and plate masses:

Rigidity of the four first elastic elements: cₓ=40 N/mm, c_{y}=11.5 N/mm, c_{z}=33 N/mm (x and y denote the directions along the plane of the plate, and z denotes the vertical).

Rigidity of the four second elastic elements: cₓ=c_{y}=42 N/mm, c_{z}=120 N/mm.

Mass of the components used: vibration plate with oscillation exciters: 24 kg, intermediate plate 40 kg, base plate with electronics and structure 23 kg.

The calculated amplitudes of the reaction forces at the base points in this configuration do not exceed 15 N at oscillation frequencies of around 50 Hz. Extensive decoupling of the base plate from the oscillations is therefore achieved.

In a second example, the rigidities of the elastic elements were left unchanged, but the intermediate plate had a mass of 60 kg. The amplitude of the reaction forces at the base points is then below 10 N at 50 Hz.

By further altering the mass of the intermediate element and also of the oscillating plate and altering the rigidities and rigidity ratios of the elastic elements, the reaction forces can be influenced further. A reduction in the rigidities cₓ and c_{y} of the second elastic elements along the plane of the plate results, for example, in further-reaching decoupling, but the static properties (in particular when heavy individuals step on the oscillating plate) may be impaired.

A basic diagram of the second aspect of the invention can be seen in FIG. 3. The system has a comparatively bulky (the mass is, for example, at least 60 kg, preferably at least 100 kg) base plate 5, on which an oscillating plate 1 is fitted by elastic elements 22. In accordance with the second aspect of the invention, the oscillation exciter comprises at least two components: at least one electric motor 26, which is decoupled from the oscillating plate and therefore to a considerable extent does not vibrate along with it, and an eccentric module 27, which has at least one weight, which is set into a rotational movement owing to rotation of a shaft and is arranged eccentrically with respect to the axis of rotation. The eccentric module 27 is coupled directly to the oscillating plate 1 in the sense that forces of inertia which act on bearings of the shaft are transferred essentially undamped to the oscillating plate. The transfer of torque between the electric motor 26 and the eccentric module 27 takes place via transfer elements 28 such as, for example, a propeller shaft (cardan shaft or the like), a drive by means of elastic belts or a chain drive etc. The transfer mechanism can be selected from among the known transfer mechanisms as long as the electric motor and the eccentric module are decoupled from one another in terms of vibrations, i.e. the transfer mechanism ensures decoupling (in the sense of the transfer of vibrations).

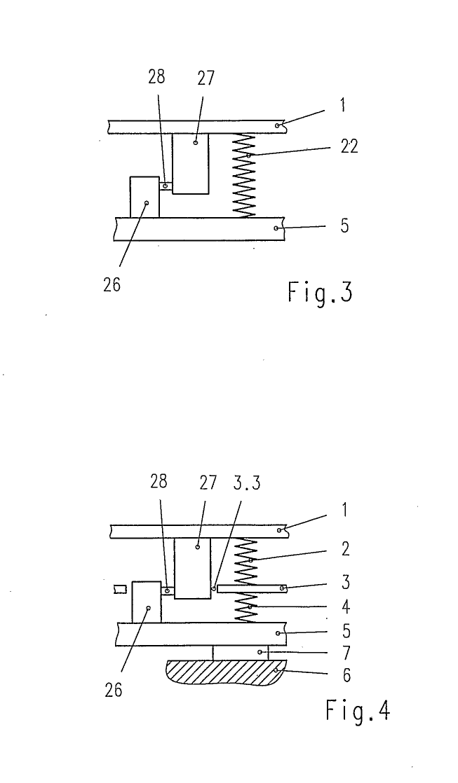

In accordance with its second aspect the invention can be used per se for any desired fitness apparatus having a vibration platform which provide a vibration drive via an eccentric module and forces of inertia; only the electric motor needs to be fitted on a component which is different than the oscillating plate and is decoupled in terms of vibrations from said oscillating plate as much as possible. However, particularly advantageous is the combination with the first aspect of the invention, since in this case the base plate or the basic frame is decoupled particularly efficiently from the vibration platform. A corresponding basic sketch can be seen in FIG. 4. The reference symbols 1 to 7 in this figure denote the same elements as in FIG. 1. The vibration drive, however, is split into two components as in FIG. 3, namely an electric motor 26 and an eccentric module 27, which are connected by means of transfer elements 28. Likewise in contrast to the configuration in FIG. 1, the plate-shaped intermediate element 3 has a cutout or opening 3.3, owing to which the connection between the electric motor 26 and the eccentric module 27 is possible. In the case of a combination of the two aspects of the invention, it is of course also possible for the intermediate element to have an intermediate-element basic body and material which can move in relation to said intermediate-element basic body, for example one which is intrinsically loose.

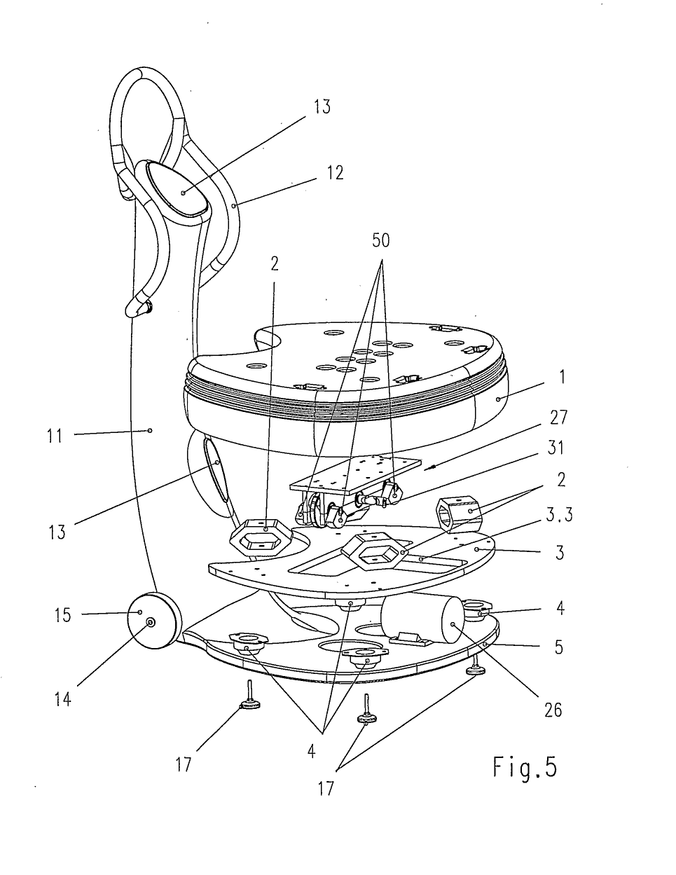

FIG. 5 shows an embodiment in accordance with the principle in FIG. 4, in an exploded illustration. The reference symbols 1-5, 11-15 and 17 denote the same elements as in FIG. 2. In contrast to FIG. 2, the fitness apparatus has only a single electric motor 26, which is fixed, for example screwed, on the base plate. It is also possible for the electric motor to be mounted on a separate component, which is likewise decoupled in terms of vibrations from the oscillating plate. For example, a cutout or opening may be provided in the base plate, through which cutout or opening the electric motor protrudes downwards, the electric motor then being screwed on a metal sheet fixed to the base plate. Space can therefore be gained.

The eccentric module 27, on the other hand, is fixedly connected to the oscillating plate 1, for example likewise screwed to it. The plate-shaped intermediate element 3 has an opening 3.3, which is in the form of a T in the embodiment illustrated and through which the electric motor can protrude from below and the eccentric module can protrude from above. A propeller shaft 31 acts as the transfer element and transfers torques from the electric motor to the eccentric module.

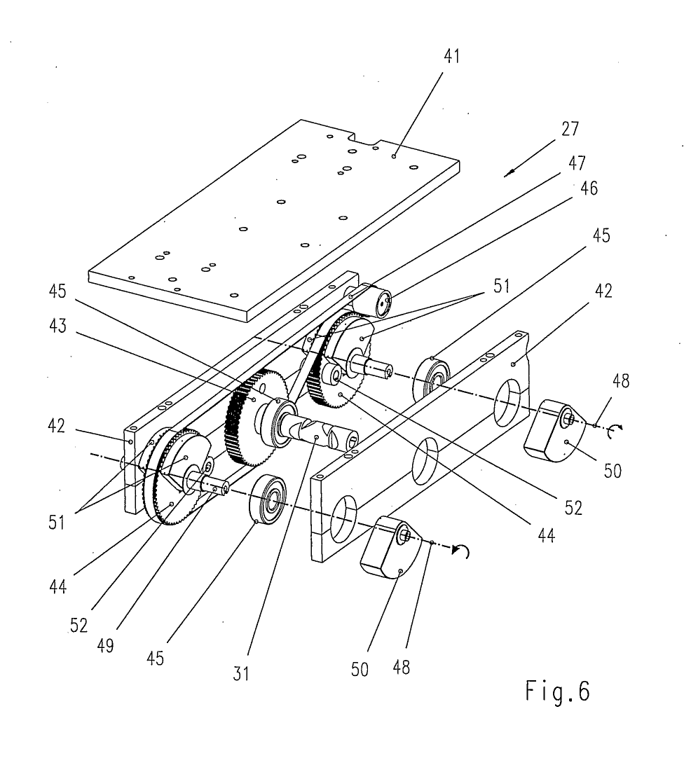

The eccentric module 27 is illustrated more clearly in FIG. 6. In the embodiment illustrated, the module has a mounting plate 41 and two webs 42, which are connected rigidly thereto. Three gearwheels 43, 44, a toothed belt 47 on both sides and a tensioning roller 46 are located between the webs 42. The gearwheels 43, 44 are guided in the webs by bearings 45 and can rotate about in each case one axis of rotation 48. As soon as the central gearwheel 43 (the input gearwheel) is set into rotational movement by the propeller shaft 31, owing to the action of the toothed belt 47, the two outer gearwheels 44 (the output gearwheels) also begin to rotate, to be precise with the illustrated guidance of the toothed belt in the opposite rotation sense. In each case one pair of eccentrics 50 is guided by the shafts 49 of the outer gearwheels (in FIG. 6 the rear eccentrics are not visible, in each case). As the pairs of eccentrics rotate in opposition, the eccentric module and therefore also the oscillating plate 1 coupled fixedly thereto vibrate primarily in the vertical direction.

The embodiment illustrated has a further special feature: in addition to the mentioned eccentrics 50, two pairs of compensating eccentrics 51 are also provided. These have, with respect to the axis of rotation, a lower degree of imbalance than the eccentrics 50, for example because they are lighter than them. In contrast to the eccentrics 50, they are not connected to the shaft in a manner such that they are fixed against rotation but can pivot in relation to said shaft. They can also be arranged directly adjacent to the gearwheels. The gearwheels have in each case two driver pins 52, owing to which, in the event of a rotational movement of the gearwheels, the compensating eccentrics are also rotated as well. In the event of a rotation in one direction of rotation, as in the drawing, in this case the compensating eccentrics 51 are arranged such that their eccentricity counteracts that of the eccentrics 50. Then, the overall eccentricity is reduced and therefore also the forces of inertia in the event of a rotation speed determined by the fixed vibration frequency. In the event of a rotation in the other direction, the compensating eccentrics automatically come to rest on the other side of their driver pin 52 (the two sides of the driver pin act as stops for the compensating eccentric), are then in the same rotary position as the eccentrics 50 and increase the imbalance and therefore the forces of inertia. With this simple measure, the vibration amplitude can therefore be varied between two values by the direction of rotation of the drive being selected.

Both the principle of transferring the drive torque from an electric motor to (at least) two eccentrics or groups of eccentrics, which are preferably rotating in opposition, by means of a toothed belt or the like and the principle of regulating the vibration amplitude by selecting the direction of rotation by means of the compensating eccentrics can also be used for embodiments in which the electric motor (or the electric motors) are fixed on the oscillating plate. In embodiments in which the eccentrics do not rest on the shaft of the electric motor and the transfer of the drive torque takes place via torque transfer means (toothed belts, gearwheels, propeller shafts, etc.), the mutual position of the eccentrics can be fixed by these transfer means. This virtually results in “forced guidance” of the eccentrics.

The above-described embodiments are merely examples of the implementation of the invention. They may be modified in some ways. The intermediate element can, for example, have a shape which differs considerably from the embodiments illustrated, for practical reasons it preferably being flat, i.e. having only a comparatively small extent in the direction at right angles to the plane of the oscillating platform. In order to be able to position the elastic elements ideally, the intermediate element will advantageously extend over a plurality of peripheral regions. For example, it may be provided as an annular element, which approximately follows the profile of the oscillating plate edge. A plurality of unconnected intermediate elements may also be provided.

In accordance with its second aspect, the invention also functions with more than one electric motor. For example, two electric motors can be arranged on the base plate, the basic frame or in the basic housing and can be equipped with in each case one transfer means for each eccentric module. Although all of the embodiments described are based on the fact that two eccentrics or groups of eccentrics are provided with an opposite rotation sense, the invention can also be realized with a single eccentric or a single group of eccentrics or else with a plurality of eccentrics/groups of eccentrics; in this case under certain circumstances more complex two-dimensional or three-dimensional oscillations are carried out instead of the essentially vertical vibrations. Many variants are also conceivable for the transfer mechanisms between the electric motor and the eccentric module and are known to a person skilled in the art in terms of the functional principle.

The transfer of torques from a shaft to the eccentric weight/the weights 50 can take place as in the described embodiment by the weights being fixed on the shaft such that they are fixed against rotation or else via driver elements, for example such as is the case for the compensating eccentrics, etc. The coupling between a propeller shaft and the shaft to which the weights are fitted can moreover also consist in the weights being fitted to one end of the propeller shaft itself, i.e. the propeller shaft being identical to the shaft of the eccentric weights.

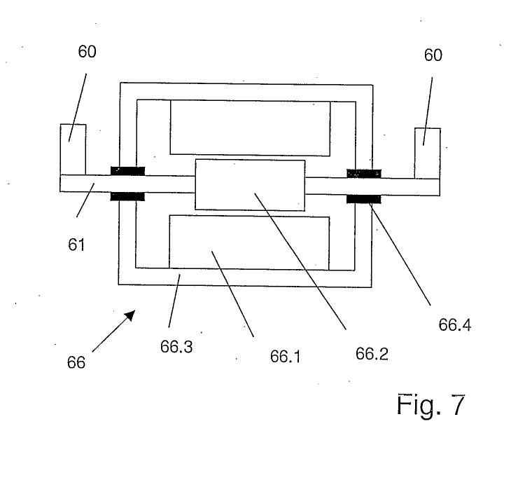

The above-described exemplary embodiments of the invention in accordance with its two aspects are each based on the fact that eccentric weights rotate in opposition to one another, with the result that, for example, only the vertical component of the forces of inertia is converted into vibration movements. This feature is not a necessity. It is also possible for eccentric weights to be used which rotate in the same direction or entirely uncoordinated, or only a single eccentric weight may also be used. One particularly preferred variant without eccentrics rotating in opposition is illustrated very schematically in FIG. 7. FIG. 7 shows an electric motor 66 (stator 66.1, rotor 66.2, housing 66.3, bearing 66.4), which drives a shaft 61. In each case one eccentric 60 is fixed on both sides of the shaft in such a manner that it is fixed against rotation. The two eccentrics are aligned with respect to one another in terms of their angular position, which means that no shear forces can result. In this illustrated embodiment, provision may of course also be made for at least one compensating eccentric to be assigned to each eccentric, it being possible for the compensating eccentric to be pivoted with respect to the shaft between two stops, the compensating eccentric being at the first stop in the event of a rotation of the shaft in one direction of rotation and being rotated along by it and being at the other stop in the event of a rotation in the other direction of rotation and being rotated along by it. As a result, the compensating eccentric can make a different contribution to the overall imbalance if it is at the first stop than if it is at the second stop. Two operating modes (high/low) therefore also result given a fixed rotation speed (which fixes the vibration frequency). The eccentric itself also moreover does not need to be mounted such that it is fixed against rotation but can be rotated along by being at stops; in this embodiment it is merely essential that the relative angular position of the eccentric and the compensating eccentric is not the same for both directions of rotation.

In the embodiment shown in FIG. 7, the forces of inertia overall act two-dimensionally, i.e. the horizontal forces of inertia are not neutralized by eccentrics rotating in opposition and vibrating forces result in the horizontal. If horizontal movements are not desirable during the vibration, these can be reduced or prevented by at least one of the following measures:
anisotropic spring forces of the (if appropriate first, possibly even second) elastic elements which provide much greater resistance to vibrations in the horizontal direction than vibrations in the vertical direction. Examples of such elastic elements are illustrated in FIG. 2,
guide means which prevent horizontal movements, for example vertical rods, which are fixed on the basic element or intermediate element and protrude into corresponding openings in the oscillating plate; these then act as a type of sliding bearing.

1. An apparatus for stimulating the human body by means of vibrations, comprising an oscillating plate which can be caused to vibrate, having a standing area and an oscillation exciter, the oscillation exciter having at least one weight which can rotate and is eccentric with respect to an axis of rotation, and drive means, by means of which the eccentric weight can be set into a rotary movement, the position of the axis of rotation of the eccentric weight being fixed in relation to the oscillating plate wherein the oscillating plate is coupled to an intermediate element via first elastic elements, and the intermediate element is coupled to a base plate, a basic frame or a basic housing, via second elastic elements.

2. The apparatus as claimed in claim 1, wherein the first and second elastic elements have a rigidity and the intermediate element has a mass that are selected such that the intermediate element forms a co-oscillating counterweight, which oscillates in phase opposition with respect to the oscillating plate.

3. The apparatus as claimed in claim 1, wherein the mass of the intermediate element or the sum of the masses of all intermediate elements is at least 20 kg.

4. The apparatus as claimed in claim 1, wherein the intermediate element is essentially in the form of a plate.

5. The apparatus as claimed in claim 4, wherein the drive means includes one or more electric motors, the intermediate element and the oscillating plate run parallel to one another, and the intermediate element has at least one opening which is located at the lateral position of at least one of the electric motors of the drive means.

6. The apparatus as claimed in claim 1, wherein the intermediate element has a material which can move in relation to an intermediate-element basic body.

7. The apparatus as claimed in claim 6, wherein the movable material is loose.

8. The apparatus as claimed in claim 1, wherein the drive means of the oscillation exciter comprise a single electric motor.

9. The apparatus as claimed in claim 8, wherein a shaft protrudes from the electric motor on two sides, and at least one eccentric weight is coupled to the shaft on both sides.

10. The apparatus as claimed in claim 1, wherein the drive means of the oscillation exciter comprise two electric motors, which each drive a shaft having at least one eccentric weight, the shafts preferably running parallel to one another and being driven with an opposite rotation sense.

11. An apparatus for stimulating the human body by means of vibrations comprising an oscillating plate, which can be caused to vibrate, and an oscillation exciter, which has at least one weight which can rotate and is eccentric with respect to an axis of rotation, and drive means by means of which the eccentric weight can be set into a rotary movement, the position of the axis of rotation of the eccentric weight being fixed in relation to the oscillating plate wherein the drive means have at least one electric motor, which is fitted on a component which is different from the oscillating plate and is coupled to said oscillating plate via elastic elements.

12. The apparatus as claimed in claim 11, wherein the component to which the electric motor is fitted is a base plate, a basic frame or a basic housing, which is provided for being placed on a foundation.

13. The apparatus as claimed in claim 12, wherein transmission means take place from at least one electric motor to a shaft, which is mounted in a fixed position in relation to the oscillating plate, via a propeller shaft.

14. The apparatus as claimed in claim 11, wherein the oscillation exciter has two eccentric weights or groups of eccentric weights, which, in the operating state, each rotate about an axis of rotation, and in that both eccentric weights or groups of eccentric weights can be driven by a single electric motor.

15. The apparatus as claimed in claim 14, wherein the axes of rotation of the eccentric weights are essentially parallel to one another, and the directions of rotation of the rotational movements of the two eccentric weights or groups of eccentric weights are opposite one another.

16. The apparatus as claimed in claim 11 wherein a compensating eccentric is assigned to at least one eccentric weight, the compensating eccentric being pivotable with respect to the electric motor shaft between two stops, the compensating eccentric being rotated towards a first stop of the two stops in the event of a rotation of the electric motor shaft in one direction of rotation and being rotated towards a second stop of the two stops in the event of a rotation of the electric motor shaft in the opposite direction of rotation, the compensating eccentric making a different contribution to an overall imbalance if it is at the first stop than if it is at the second stop.

17. The apparatus as claimed in claim 16, wherein the at least one eccentric weight is coupled to the electric motor shaft in a manner in which it is fixed against rotation about the electric motor shaft, and in that the imbalance caused by the compensating eccentric increases the overall imbalance if it is at the first stop, whereas the imbalance of the at least one eccentric weight is at least partially compensated for by the imbalance caused by the compensating eccentric if said compensating eccentric is at the second stop.

18. The apparatus as claimed in claim 12, wherein the base plate, basic frame, or basic housing is supported on the foundation by damping elements.

19. The apparatus as claims in claim 1, wherein the mass of the intermediate element or the sum of the masses of all intermediate elements is at least 35 kg.
